(19) United States
(12) Patent Application Publication
(10) Pub. No.: US 2015/0244413 A1
(43) Pub. Date: Aug. 27, 2015

(54) Method and Device for Cancelling Interference

(71) Applicant: Broadcom Corporation, Irvine, CA (US)

(72) Inventors: Pierre BAUDIN, Rennes (FR); Mikael GUENAIS, Rennes (FR)

(73) Assignee: Broadcom Corporation, Irvine, CA (US)

(21) Appl. No.: 14/190,063

(22) Filed: Feb. 25, 2014

(51) Int. Cl. H04B 1/52

(52) U.S. Cl. CPC H04B 1/525

(57) ABSTRACT

The invention discloses a method and device for cancelling, from a radio signal received by the radio device in a first frequency band, the interference generated through a nonlinearity of the radio device when the radio device transmits a radio signal on at least a second frequency band simultaneously with the received radio signal, the at least one second frequency band being different from the first frequency band, the transmitted radio signal being obtained from digital signal.

### TECHNICAL FIELD

The present invention generally relates to a method and a device for cancelling from signals received by a radio device in a first frequency band, interference generated by the radio device when the radio device transmits simultaneously radio signal on at least a second frequency band.

### BACKGROUND

Homodyne receivers, also known as direct-conversion receivers, which are widely used in modern communication systems, are very sensitive to even order distortion. Second Order Intermodulation Interception Point (IIP2) of homodyne down-converter may generate interferences when the radio device transmits simultaneously radio signal on at least a second frequency band.

For example, in new wireless cellular telecommunication networks and in particular in the Third Generation Partnership Project, Long Term Evolution advanced, new features are considered. One of the new features is Carrier Aggregation. Uplink/Downlink Carrier Aggregation enables mobile terminals to transmit/receive simultaneously on two frequencies in two different frequency bands, thus doubling the theoretical throughput in Uplink/Downlink.

In the example of Uplink Carrier Aggregation, the mobile terminal transmits simultaneously signals in at least one frequency band which is different from the frequency band the mobile terminal uses for receiving radio signals.

According to allocated frequency bands for radio signals transmission and/or reception, by using plural frequency bands for radio signals transmission, inter-modulation products of the transmitted signals generated through nonlinearity may fall into the frequency band used by the mobile terminal for receiving radio signals.

### BRIEF DESCRIPTION OF THE DRAWINGS

FIG. 1 schematically presents an example of intermodulation from two transmission frequency bands which fall into a receive frequency band;

FIG. 2 schematically represents an architecture of a radio device in which the present invention is implemented;

FIG. 3 illustrates a part of the wireless interface of the radio device according to the present invention;

FIG. 4 represents an algorithm executed by the radio device according to the present invention.

### DETAILED DESCRIPTION

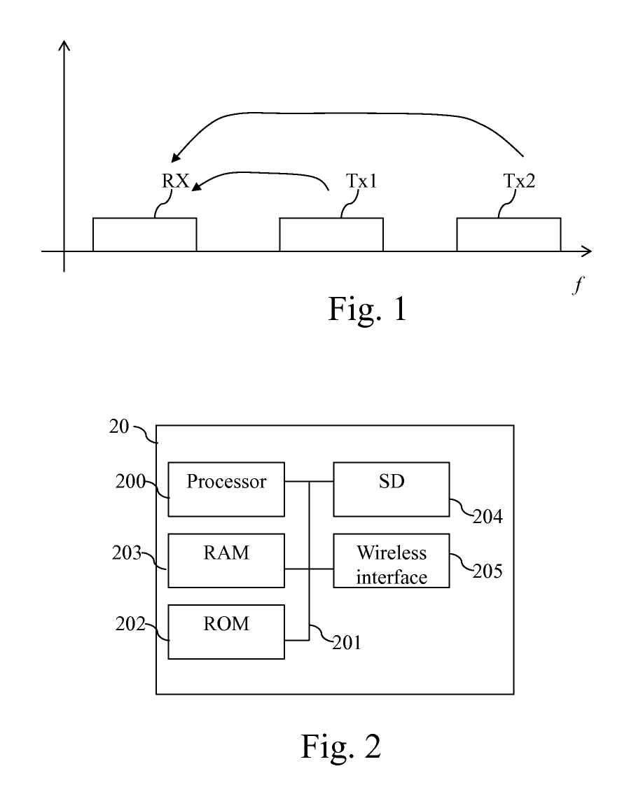

Certain situation exist where interference is caused when a mobile terminal simultaneously transmits signals in at least one frequency band which is different from the frequency band the mobile terminal uses for receiving radio signals., This interference degrades the performance of the mobile terminal. An example of such situation is disclosed in reference to FIG. 1.

FIG. 1 schematically presents an example of intermodulation between two transmit signals which fall into a receive frequency band. FIG. 1 represents the frequency spectrum in which a first frequency band RX, is used by the radio device for the reception of downlink signals. A second and third frequency bands Tx1 and Tx2 are used by the radio device for the transmission of uplink signals.

As an example, the frequency band RX is from 791 MHz to 821 MHz, the frequency band Tx1 is from 832 MHz to 862 MHz and the frequency band Tx2 is from 880 MHz to 915 MHz. In this case, it can happen that the two transmit signals, a first transmit signal in the frequency band Tx1 laying at carrier frequency F_{TX1}, a second transmit signal in the frequency band Tx2 laying at carrier frequency F_{TX2}, are such that the third order intermodulation of the first and second transmit signals falls into the RX frequency band when we have for instance 2×F_{TX1}-1×F_{TX2}F_{RX}, the carrier frequency of the frequency band RX.

As can be understood with the example given in FIG. 1, the sensitivity in first frequency band RX can be significantly degraded if the intermodulation products between the first and second transmit signals is in the range or significantly higher than the power of the downlink received signal.

Various stages exhibiting a nonlinear behavior may be the origin of such intermodulation. It can be for instance the early Low Noise Amplifier (LNA) stage used for amplifying received signals or the RX filter in the duplexer that has a linear effect and at least a stage of the receiver that has some nonlinear effect.

Embodiments of the invention present a method and a device for reducing interferences generated in the receive band through the nonlinear distortion of the signals transmitted by the radio device in other frequency bands. To that end, a method is presented for cancelling, from a radio signal received by a radio device in a first frequency band, the interference generated through a nonlinearity of the radio device when the radio device transmits a radio signal on at least a second frequency band simultaneously with the received radio signal, the at least one second frequency band being different from the first frequency band, the transmitted radio signal being obtained from a digital signal, said method causing the device to perform:
receiving, with a sensing receiver, the analog radio signal in the second frequency band, and converting the received signal into a first sensed digital signal,—obtaining digital signal that is intended to be used for generating the radio signal that is transmitted in the at least one second frequency band,
performing, using the first sensed digital signal, a first adaptive filtering on the obtained digital signal in order to provide filtered obtained digital signal,
digitally generating a non-linearity on the filtered obtained digital signal, in order to provide digital interference,
cancelling interference from the signal received by the radio device in the first frequency band, using the digital interference.

A radio receiving device is presented for cancelling, from a radio signal received by a radio device in a first frequency band, the interference generated through a nonlinearity of the radio device when the radio device transmits a radio signal on at least a second frequency band simultaneously with the received radio signal, the at least one second frequency band being different from the first frequency band, the transmitted radio signal being obtained from digital signal, the device comprising circuitry causing the device to implement:
receiving device for cancelling, from a radio signal received by a radio device in a first frequency band, the interference generated through a nonlinearity of the radio device when the radio device transmits a radio signal on at least a second frequency band simultaneously with the received radio signal, the at least one second frequency band being different from the first frequency band, the transmitted radio signal being obtained from digital signal, the device comprising circuitry causing the device to implement:
means for receiving, with a sensing receiver, the analog radio signal in the second frequency band, and converting the received signal into a first sensed digital signal,
means for obtaining digital signal that is intended to be used for generating the radio signal that is transmitted in the at least one second frequency band,
means for performing, using the first sensed digital signal, a first adaptive filtering on the obtained digital signal in order to provide filtered obtained digital signal,
means for digitally generating a non-linearity on the filtered obtained digital signal, in order to provide digital interference,
means for cancelling interference, from the signal received by the radio device in the first frequency band, using the digital interference.

Thus, embodiments of the present invention reduce interferences generated in a receive frequency band through a nonlinear distortion of the signals transmitted by the radio device in other frequency bands.

At least one embodiment is presented with a computer program that can be downloaded from a communication network and/or stored on a medium that can be read by a computer or processing device. This computer program comprises instructions for causing implementation of the aforementioned method, or any of its embodiments, when said program is run by a processor.

Another embodiment also comprises an information storage means, storing a computer program comprising a set of instructions causing implementation of the aforementioned method, or any of its embodiments, when the stored information is read from said information storage means and run by a processor.

An embodiment also may comprise an information storage means, storing a computer program comprising a set of instructions causing implementation of the aforementioned method, or any of its embodiments, when the stored information is read from said information storage means and run by a processor.

FIG. 2. schematically represents an architecture of a radio device in which the present invention is implemented.

The radio device 20 comprises the following components interconnected by a communications bus 201: at least one processor, microprocessor, microcontroller or CPU (Central Processing Unit) 200; a RAM (Random-Access Memory) 203; a ROM (Read-Only Memory) 202; an SD (Secure Digital) card reader 204, or any other device adapted to read information stored on storage means; a wireless interface 205. The wireless interface 205 allows the radio device 20 to wirelessly communicate with another radio device.

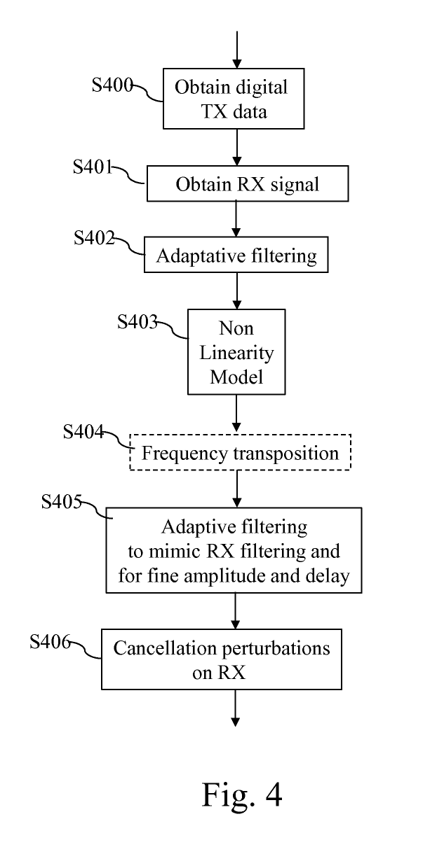

Processor 200 is capable of executing instructions loaded into RAM 203 from ROM 202 or from an external memory, such as an SD card. When the radio device 20 is powered on, processor 200 reads instructions from RAM 203 and executes the read instructions. The instructions form one computer program that causes processor 200 to perform some or all of the steps of the algorithm described hereafter with regard to FIG. 4.

Any and all steps of the algorithm described hereafter with regard to FIG. 4 may be implemented in software by execution of a set of instructions or program by a programmable computing machine, such as a PC (Personal Computer), a DSP (Digital Signal Processor) or a microcontroller; or else implemented in hardware by a machine or a dedicated component, such as an FPGA (Field-Programmable Gate Array) or an ASIC (Application-Specific Integrated Circuit).

In other words, the radio device 20 includes circuitry, or a device including circuitry, causing the receiver device to perform the steps of the algorithm described hereafter with regard to FIG. 4. Such a device including circuitry causing the radio device 20 to perform the steps of the algorithm described hereafter with regard to FIG. 4 may be an external device connectable to the radio device 20.

The radio device 20 may also be a part of another device, for example when the radio device 20 is a chip, a chipset, or a module. Alternatively, instead of being a part of another device or connected to a dedicated communication device, the radio device 20, according to the invention, may provide communication capability to any suitable device, such as a computer device, a machine, for example a vending machine or a vehicle like a car or truck.

The term circuitry refers either to hardware implementation, consisting in analog and/or digital processing, or to a combination of hardware and software implementation, including instructions of computer program associated with memories and at least one processor causing the at least one processor 200 to perform any and all steps of the algorithm described hereafter with regard to FIG. 4.

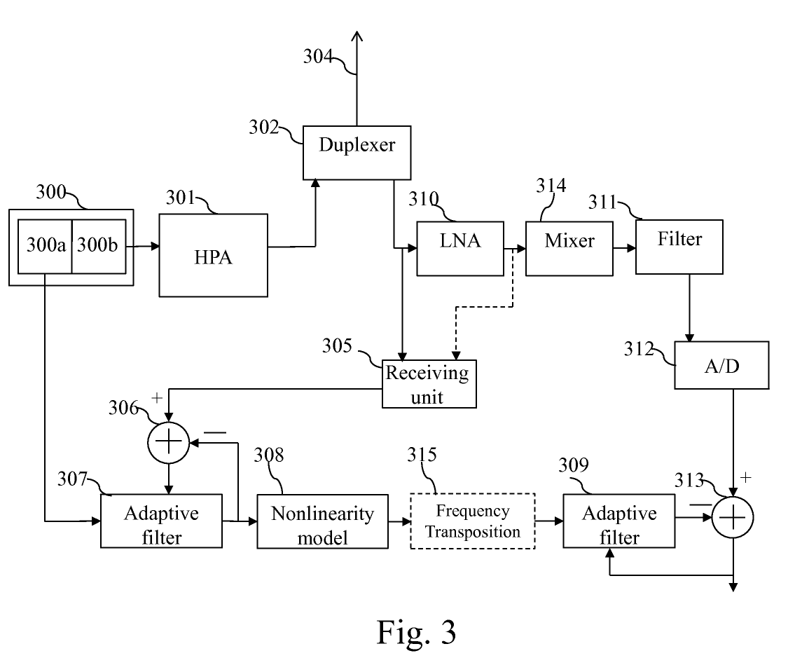

FIG. 3 illustrates a part of the wireless interface of the radio device according to the present invention. For clarity reasons, this illustration is a simplified example, which describes some of the most necessary parts of such device, and the device may include several further components without departing from the scope of the invention. For simplification, the schematic also shows just a single signal chain for each signal path (transmit, receive, sensing). In actual implementation, more than one signal chains may exists in any of the signal paths. An example of such multiple signal chains is I (in phase) and Q (quadrature) paths.

The wireless interface 205 comprises a Radio Frequency Integrated Circuit (RFIC) 300 which processes signals to be transmitted. The RFIC 300 comprises a digital part 300a and an analog part 300b.

The analog signals output by the RFIC 300 are processed by analog transmit signal processing chain, represented here with 301, which may generate inter-modulation products between at least a first and a second transmit signals. For example, the analog signal processing chain may comprise a High Power Amplifier (HPA) 301, also called Power Amplifier. This amplifier may have adjustable gain. In addition to the exemplary HPA, the analog transmit signal processing chain may contain one or more further signal processing devices such as filters and/or amplifiers and/or mixers, all of which may introduce intermodulation products between at least a first and a second transmit signals.

The analog signal output by the RFIC are amplified by a High Power Amplifier (HPA) 301. In this example, the signal from the analog signal processing chain 301 are fed to the antenna 304 through a duplexer 302. The duplexer 302 comprises at least one processing unit which processes the signal in the frequency bands used for transmitting signal and also the signal in the frequency band used by the radio device for receiving signal. The processing unit included in the duplexer 302 is for example a filter which may also introduce intermodulation products between at least a first and a second transmit signals on the signals amplified by the HPA 301. It has to be noted here that if the radio device is a mobile terminal and has Uplink Carrier Aggregation capability, the components 300 to 302 are duplicated as many time as the radio device can transmit simultaneously signal on carriers of different frequency bands. This signal may be a single uplink carrier or a carrier aggregation signal, which may comprise multiple sub-carriers, which may reside on same or different frequency bands. In the receive side, the duplexer 302 is connected to a low noise amplifier 310 of a reception part of the wireless interface 205.

The duplexer 304 comprises at least one filter on the RX path which introduces linear distortions on the on transmitted signals.

The amplified signals are then down-converted to a baseband frequency with one or more mixer elements 314. Down conversion may also introduce second order AM components.

The signals output by the mixer 314 are filtered by a filter 311. The non-linearity and/or inter-modulation components that are in the reception frequency band are not cancelled by the filter 311.

The filtered signals are converted into digital received signals by an analog to digital converter A/D 312.

When the duplexer 302 introduces linear distortion, its output signal can be sensed through a receiving unit 305.

The receiving unit 305 is, for example, a reception chain used for control purpose. The receiving unit 305 at least converts the analog signals at the input of the low noise amplifier LNA 310 into digital signals. The receiving unit 305 is often embedded in most of modern wireless transceivers as a sensing receiver a.k.a a measurement receiver used for various purposes like power control and/or antenna tuning

The digital samples provided by the receiving unit 305 are provided to a subtracting module 306.

The subtracting module 306 subtracts the digital samples provided by the receiving unit 305 from the digital samples provided by an adaptive filter 307 and provides resulting samples to the adaptive filter 307.

The digital signals output by the digital RFIC part 300a are provided to the adaptive filter 307.

The adaptive filter 307, using the samples provided by the digital RFIC part 300a and samples provided by the subtracting module 306, generates an image of the transmit signals as it appears after having experienced the linear distortion introduced in the front-end part of the system, i.e. by at least the duplexer 302. Purpose of the adaptive filter 307 is to reconstruct in the digital domain the in-phase and in-quadrature components of the transmit signal(s) as present at the input of the analog part of the signal chain introducing non-linearities.

The samples output by the adaptive filter 307 are provided to a non-linearity model module 308.

The non-linearity model module 308 generates or mimics, in digital domain, the non-linearities introduced in the analog part of the signal chain by processing the samples output from the adaptive filter 307, like Second Order Intermodulation Interception Point (IIP2) of homodyne down-converter and generates a representation of the interference from the digital signals provided by the digital RFIC transmit part 300a. For example, the nonlinearity model module 308 generates the second and/or the third harmonics.

The output of the non-linearity model module 308 is provided to a frequency transposition module 315, which transposes the interferences resulting from the non-linearity into the frequency band used by the radio device 20 for receiving signals.

It has to be noted, that the frequency transposition module 315 may not be needed if the interferences resulting from the non-linearity are already at the same received frequency as the one used by the radio device 20 for receiving signals. According to the invention, the output of the frequency transposition module 315 or the output of the non-linearity model module 308 is provided to a second adaptive filter 309. This optional nature of the transposition module 315 is highlighted by dashed line in FIG. 3.

The second adaptive filter 309 mimics the various receive filters and adapts the amplitude and the delay of the samples provided by the non-linearity model module 308 to the samples generated by the reception part 302, 310, 311, 312 and 314.

The samples output by the adaptive filter 309 are subtracted from the digital received signal or samples output by the analog to digital converter 312 by a subtracting module 313.

The samples provided by the subtracting module 313 are then free or almost free of interference linked to the transmit signals introduced by the analog reception chain 302 and 310.

FIG. 4 represents an algorithm executed by the presented radio device. At step 5400, the processor 200 obtains digital signal that is intended to be used for generating the radio signals that are transmitted in the at least one second frequency band.

At next step 5401, the processor 200 obtains the digital samples of the analog radio signal received in the second frequency band with a sensing receiver and converting the sensed signal into a first sensed digital signal. The analog radio signal received in the first frequency band is the signal at the input or the output of the low noise amplifier 310 which is digitized by the receiving unit 305.

At next step 5402, the processor 200 performs, using the first received digital signal, a first adaptive filtering on the obtained digital signal in order to provide filtered obtained digital signal.

The adaptive filtering is performed using the samples provided by the digital RFIC part 300a and samples provided by the subtracting module 306. The processor 200 generates a digital image of the transmit signal as it appears after having experienced the linear distortion introduced in the front-end part of the system, i.e. by at least the duplexer 302. The purpose of the adaptive filter 307 is to reconstruct in the digital domain the in-phase and in-quadrature components of the transmit signal(s) as present at the input of the non-linearity.

At next step S403, the processor 200 digitally generates a non-linearity on the filtered obtained digital signal, in order to provide digital interference. The processor 200 generates samples of harmonics of the digital signals provided by the digital RFIC part 300a and/or intermodulation products of the signals transmitted by the radio device. For example, harmonics are the second and/or the third harmonics.

In next step S404, the processor 200 performs a frequency transposition of the samples of representation of the interferences resulting from the non-linearity into the frequency band used by the radio device 20 for receiving signals.

It has to be noted here that, the frequency transposition step S404 may not be needed if the interferences resulting from the non-linearity are already in the frequency band used by the radio device 20 for receiving signals. Optional characteristic of this step is highlighted with dashed line.

At next step S404, the processor 200 performs a second adaptive filtering in order to adjust the amplitude and the delay of the samples provided by step S403 to the samples generated by the reception part 302, 310, 311, 312 and 314.

At next step S505, the processor 200 cancels the harmonics and/or intermodulation products and/or distortions introduced by the reception part 302 and 310.

The samples output by the adaptive filtering step S404 are subtracted from the samples output by the analog to digital converter 312. The exemplary analog to digital converter 312 is used for converting the received radio signal received by the radio device in the first frequency into a digital received signal, and the cancelling of the interference is effected by subtracting the digital interference from this digital received signal. The implementation of the receiver chain and generation of the digital received signal as such is outside the scope of the presented solution, and any suitable receiver architecture and method for analog to digital conversion may be applied to generate the digital received signal.

1. A method for cancelling, from a radio signal received by a radio device in a first frequency band, the interference generated through a nonlinearity of the radio device when the radio device transmits a radio signal on at least a second frequency band simultaneously with the received radio signal, the at least one second frequency band being different from the first frequency band, the transmitted radio signal being obtained from digital signal, wherein said method causing the device to perform:
receiving, with a sensing receiver, the analog radio signal in the second frequency band, and converting the received signal into a first sensed digital signal,
obtaining digital signal that is intended to be used for generating the radio signal that is transmitted in the at least one second frequency band,
performing, using the first sensed digital signal, a first adaptive filtering on the obtained digital signal in order to provide filtered obtained digital signal,
digitally generating a non-linearity on the filtered obtained digital signal, in order to provide digital interference,
cancelling interference from the signal received by the radio device in the first frequency band, using the digital interference.

2. The method according to claim 1, wherein it further causes the device to perform:
amplifying and filtering the signal received by the radio device and analog to digital converting the amplified signal in order to obtain digital received signal.

3. The method according to claim 1, wherein it further causes the device to perform:—executing a second adaptive filtering on the digital interference in order to adapt the amplitude and the delay of the digital interference to the digital received signal.

4. The method according to claim 1, wherein the interference is a intermodulation product of signals transferred by the radio device simultaneously on two different frequency bands and/or harmonics generated by non-linearity in amplification of the signals received by the radio device and/or harmonics of the signal transmitted by the radio device.

5. The method according to claim 1, wherein the method causing the device to perform a frequency transposition of the digital interference.

6. The method according to claim 2, characterized in that the cancelling of the interference comprises subtracting the digital interference from the digital received signal.

7. An apparatus for cancelling, from a radio signal received by a radio device in a first frequency band, the interference generated through a nonlinearity of the radio device when the radio device transmits a radio signal on at least a second frequency band simultaneously with the received radio signal, the at least one second frequency band being different from the first frequency band, the transmitted radio signal being obtained from digital signal, the apparatus comprising a processing system that comprises at least one data processor and at least one computer-readable memory storing a computer program, wherein the processing system is configured to cause the apparatus at least to:
receive, with a sensing receiver, the analog radio signal in the second frequency band, and converting the received signal into a first sensed digital signal,
obtain digital signal that is intended to be used for generating the radio signal that is transmitted in the at least one second frequency band,
perform, using the first sensed digital signal, a first adaptive filtering on the obtained digital signal in order to provide filtered obtained digital signal,
digitally generate a non-linearity on the filtered obtained digital signal, in order to provide digital interference,
cancel interference from the signal received by the radio device in the first frequency band, using the digital interference.

8. The apparatus according to claim 7, wherein the processing system is further configured to cause the apparatus to:
amplify and filter the signal received by the radio device and analog to digital converting the amplified signal in order to obtain digital received signal.

9. The apparatus according to claim 7, wherein the processing system is further configured to cause the apparatus to:
execute a second adaptive filtering on the digital interference in order to adapt the amplitude and the delay of the digital interference to the digital received signal.

10. The apparatus according to claim 7, wherein the interference is a intermodulation product of signals transferred by the radio device simultaneously on two different frequency bands and/or harmonics generated by non-linearity in amplification of the signals received by the radio device and/or harmonics of the signal transmitted by the radio device.

11. The apparatus as according to claim 7, wherein the processing system is further configured to cause the apparatus to perform a frequency transposition of the digital interference.

12. The apparatus according to claim 8, characterized in that the processing system for cancelling interference further comprises circuitry for subtracting the digital interference from the digital received signal.

13. A computer readable memory storing a computer program for cancelling, from a radio signal received by a radio device in a first frequency band, the interference generated through a nonlinearity of the radio device when the radio device transmits a radio signal on at least a second frequency band simultaneously with the received radio signal, the at least one second frequency band being different from the first frequency band, the transmitted radio signal being obtained from digital signal, wherein the computer program is executable by at least one processor and comprises:
code for receiving, with a sensing receiver, the analog radio signal in the second frequency band, and converting the received signal into a first sensed digital signal,
code for obtaining digital signal that is intended to be used for generating the radio signal that is transmitted in the at least one second frequency band,
code for performing, using the first sensed digital signal, a first adaptive filtering on the obtained digital signal in order to provide filtered obtained digital signal,
code for digitally generating a non-linearity on the filtered obtained digital signal, in order to provide digital interference,
code for cancelling interference from the signal received by the radio device in the first frequency band, using the digital interference.

14. The computer readable memory of claim 13, wherein the computer program further comprises:
code for amplifying and filtering the signal received by the radio device and analog to digital converting the amplified signal in order to obtain digital received signal.

15. The computer readable memory of claim 13, wherein the computer program further comprises:
code for executing a second adaptive filtering on the digital interference in order to adapt the amplitude and the delay of the digital interference to the digital received signal.

16. The computer readable memory of claim 13, the interference is a intermodulation product of signals transferred by the radio device simultaneously on two different frequency bands and/or harmonics generated by non-linearity in amplification of the signals received by the radio device and/or harmonics of the signal transmitted by the radio device.

17. The computer readable memory of claim 13, wherein the computer program further comprises code for causing the device to perform a frequency transposition of the digital interference.

18. The computer readable memory of claim 14, wherein the code for cancelling of the interference further comprises subtracting the digital interference from the digital received signal.
